(19) United States
(12) Patent Application Publication
(10) Pub. No.: US 2017/0254322 A1
(43) Pub. Date: Sep. 7, 2017

(54) AIR COMPRESSOR MADE OF A LIGHT METAL

(71) Applicant: WABCO GmbH, Hannover (DE)

(72) Inventor: Uwe OPPERMANN, Salzhemmendorf (DE)

(21) Appl. No.: 15/510,491

(22) PCT Filed: Aug. 26, 2015
(86) PCT No.: PCT/EP2015/001737

§ 371 Date: Mar. 10, 2017

(30) Foreign Application Priority Data
Sep. 11, 2014 (DE) 10 2014 013 442.3

(51) Int. Cl. F04B 39/12; B60T 13/26; F04B 53/14; F04B 39/00; F04B 39/10

(52) U.S. Cl. CPC F04B 39/121; F04B 39/0094; F04B 39/10; F04B 39/125; F04B 39/128; F04B 53/143; B60T 13/26

(57) ABSTRACT

Disclosed is an air compressor (10) for supplying compressed air to a pneumatic system in a motor vehicle. The air compressor (10) comprises a crankcase (46), a cylinder housing (14) connected to the crankcase, a cylinder head (20), a crankshaft (40) rotatably mounted in the crankcase, a cylindrical piston (12) that is connected to the crankshaft (40) by a connecting rod (42). In order to load the compressed air with as little heat as possible, the crankcase (46), the cylinder housing (14), the cylinder head (20), and the piston (12) are made of aluminum or an aluminum alloy, and the at least one piston ring (54) or the at least one oil ring is made of gray cast iron or polytetrafluoroethylene (PTFE).

### CROSS-REFERENCE TO RELATED APPLICATIONS

This application is the National Stage of International Application No. PCT/EP2015/001737, filed on 26 Aug. 2015, which claims priority to and all advantages of German Patent Application No. 10 2014 013 422.3, filed on 11 Sep. 2014, the content of which is hereby incorporated by reference.

### FIELD OF THE INVENTION

The invention generally relates to an air compressor and, more specifically, to an air compressor to supply a compressed air system of a motor vehicle with compressed air.

### BACKGROUND OF THE INVENTION

Compressors for generating compressed air are used, among other things, to operate pneumatic brake systems in motor vehicles and rail vehicles. In order to achieve high efficiency, the ambient air taken in by the compressor should where possible only be heated to a small degree before a compression chamber in the compressor is reached. The input of heat into the cylinder head of a compressor is principally caused by the compression heat which is released in the compression chamber. The significantly heated cylinder head inevitably discharges its heat to the intake air which is generally conducted in at least one intake duct within the cylinder head to the compression chamber. A particularly intensive heat input into the intake air is carried out in this case in the region of the openings of the intake duct to the suction plate. A reduction in the intake air temperature simultaneously also brings about a significant reduction in the final compression temperature with all the advantages which are sufficiently known to the person skilled in the art.

DE 698 26 381 T2 relates to a piston compressor with a water-cooled cylinder head for compression of gases or gas mixtures, such as, for example, air. The cylinder head is composed of aluminum which is known to have high heat conductivity. Moreover, air cooling ribs on the inside of the cylinder head and adjacent to these flow galleries are formed in order to discharge the released compression heat from the cylinder head into the surroundings. For further optimization of cooling, a plurality of water-cooling ducts are incorporated into the cylinder head, and cooling ribs formed in one piece are arranged within the flow path of the outlet air.

Moreover, a two-cylinder air compressor is known from DE 10 2007 023 192 A1, the crankcase of which is produced from an aluminum cast material. This results in a reduction in weight by 40% to 50% in comparison to a known crankcase made of a cast steel. The total weight of the air compressor is also significantly reduced so that, after its installation in a motor vehicle, as a result its fuel consumption and its pollutant emissions can be advantageously reduced. Moreover, it is already pointed out in this publication that the specific heat conductivity of cast aluminum is approximately sixty times higher than that of cast steel so that heat generated during operation of the compressor can be better discharged therefrom than in the case of a compressor made of steel. In the case of this air compressor, the pistons are accommodated axially displaceably in sleeve-shaped working cylinders which, according to FIG. 6 thereof, are clearly inserted in a positive-locking and non-positive manner into the crankcase made of aluminum. DE 10 2007 023 192 A1 provides no information as to the material from which the sleeve-shaped working cylinders and the pistons or their piston rings are composed.

### SUMMARY OF THE INVENTION

The present invention provides an air compressor, wherein at least one piston and/or its at least one piston ring is/are formed such that these can come into direct frictional contact with the cylinder lateral surface of the cylinder housing without damage.

In certain embodiments, as described below, all the essential thermally loaded components of the air compressor are composed of aluminum or an aluminum alloy, and the at least one piston ring is composed of a grey cast iron alloy or from polytetrafluoroethylene (PTFE). A piston ring composed of grey cast iron has, as a result of its structure, certain lubrication properties which make it possible to guide this piston ring directly on the cylinder lateral surface of the air compressor, in particular if composed of aluminum or an aluminum alloy.

The invention therefore relates to an air compressor, for example, to supply a compressed air system of a motor vehicle with compressed air, the air compressor having a crankcase, a cylinder housing connected to the crankcase, a cylinder head, a crankshaft arranged in a rotatably mounted manner in the crankcase, a cylindrical piston connected via a connecting rod to the crankshaft, which piston is arranged axially movably along a cylindrical running surface of the cylinder housing, at least one piston ring or oil scraper ring which is arranged in an annular groove on outer lateral surface of the piston, a compression chamber which is formed above the piston and is closed off by the cylinder head, further having an intake duct and an outlet duct which are formed in a cylinder head upper part of the cylinder head, wherein the intake duct is assigned at least one suction valve and the outlet duct is assigned at least one pressure valve, and in the case of which the crankcase and the cylinder housing are produced using aluminum or an aluminum alloy. The crankcase and the cylinder housing can be formed here together in one piece.

In certain embodiments, the crankcase, the cylinder housing, the cylinder head and the piston are produced from aluminum or an aluminum alloy, and the at least one piston ring or the at least one oil scraper ring is produced from grey cast iron or from polytetrafluoroethylene (PTFE).

In these embodiments, all those main components of the air compressor which come into direct contact with the air which is to be compressed or has already been compressed are composed of a material with very good heat conductivity. The compression heat generated during operation of the air compressor and the friction heat can be easily discharged from the air compressor via these components. This can be carried out in a familiar manner with coolant ducts conducting a cooling fluid, which ducts are arranged on or in the crankcase or cylinder housing. As a result of the use of piston rings or oil scraper rings which are composed of grey cast iron or from polytetrafluoroethylene (PTFE), the use of separate cylinder sleeves as friction partners for the piston(s) or their piston rings or oil scraper rings can be dispensed with.

In certain embodiments, the crankcase, the piston and the cylinder housing are produced from an aluminum alloy which has a silicon ratio of at most 25% and has a hardness of at least 90 HB (Brinell). In tests, such an alloy has been shown to be particularly advantageous.

Further tests have shown advantages when the crankcase, the piston and the cylinder housing are composed of the aluminum alloy AlSi12 CuNiMg, AlSi17 Cu4MG or AlSi9 Cu3(F2). With regard to the aluminum alloy AlSi9 Cu3(F2), it should nevertheless be provided that this material is additionally heat-treated after the casting process. Although the use of the stated aluminum alloys is advantageous, the piston can, however, also be produced from a different aluminum alloy.

The at least one piston ring is preferably formed as a taper-faced ring or as a groove taper-faced ring. The piston ring can, however, also be formed as a simple oil scraper ring. As required, one to five piston rings and/or oil scraper rings should be arranged on each piston.

The at least one piston ring or the at least one oil scraper ring may be produced, as mentioned, from a grey cast iron material. Tests have shown that it is advantageous if the at least one piston ring or the at least one oil scraper ring is composed of a standard grey cast iron material with a hardness of up to 295 HB (Brinell), from a low-alloyed standard grey cast iron material with a hardness of up to 295 HB, from an alloyed and thermally processed grey cast iron material with a hardness of up to 380 HB, from a tempered spheroidal cast material with a hardness of up to 360 HB, or an alloyed and tempered grey cast iron material with a hardness of up to 410 HB.

In various embodiments, the outer diameter of the at least one piston ring is selected in relation to the inner diameter of the assigned cylindrical running surface of the cylinder housing in such a manner that the piston ring bears with a contact force of 5 N to 20 N against the cylindrical running surface. It is preferably provided in this case that the piston ring bears with a contact force of 9 N to 13.5 N against the cylindrical running surface.

In so far as at least one oil scraper ring is arranged on the respective piston, it is advantageous if the outer diameter of the at least one oil scraper ring is selected in relation to the inner diameter of the assigned cylindrical running surface of the cylinder housing such that the oil scraper ring bears with a contact force of 10 N to 60 N against the cylindrical running surface. It is preferably provided in this case that the oil scraper ring bears with a contact force of 27.2 N to 40.8 N against the cylindrical running surface.

### BRIEF DESCRIPTION OF THE DRAWING

The invention is described in greater detail below with reference to the accompanying figure, in which:

FIG. 1 shows an air compressor in a schematic longitudinal section.

### DETAILED DESCRIPTION

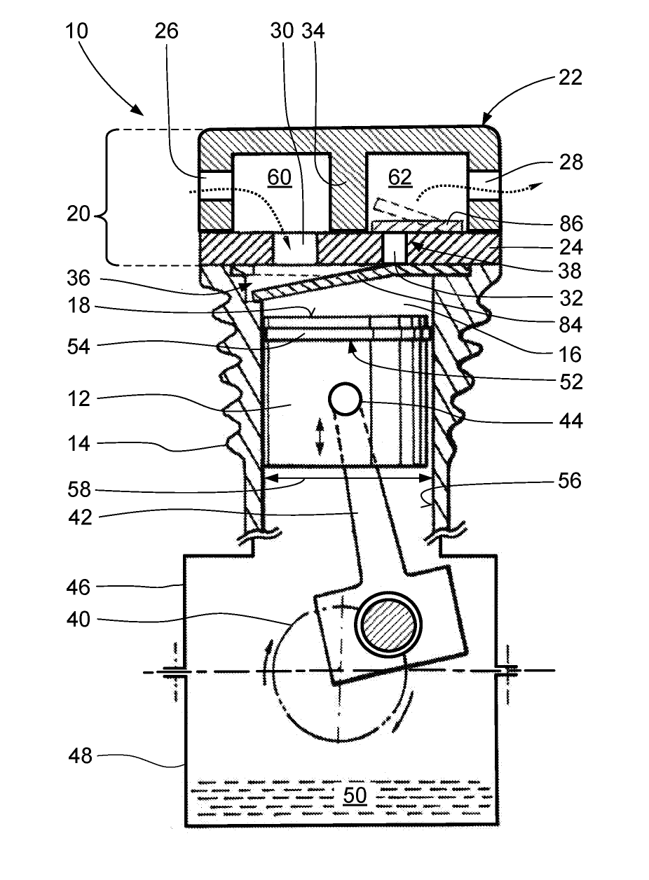

FIG. 1 shows an air compressor 10, which can be, for example, a compressed air compressor for a brake system of a utility vehicle, the air compressor 10 having a piston 12 which is arranged to be axially movable to and fro in a cylinder housing 14. A compression chamber 16 above a piston upper side 18 is closed off towards the top by a cylinder head 20. Cylinder head 20 is composed of a cylinder head upper part 22 and an intermediate plate 24.

Cylinder head upper part 22 is provided with an intake duct 26 and an outlet duct 28 which are connected in terms of flow via a pot-shaped inlet chamber 60 or a pot-shaped outlet chamber 62 to an inlet opening 30 or an outlet opening 32 in the intermediate plate 24. Intake duct 26 and outlet duct 28 are separated from one another in terms of flow in cylinder head upper part 22 by a web 34 which is formed in one piece with cylinder head upper part 22 and runs approximately parallel to the axis of movement of piston 12. There is arranged on the piston side of intermediate plate 24 a suction valve 36 in the form of a reed valve which opens in the case of the intake cycle shown in the represented manner, to which end its disk 84 lifts up from inlet opening 30 in intermediate plate 24 in order to suck air with atmospheric pressure from the surroundings into combustion chamber 16.

Suction valve 36 closes when piston 12 begins the compression stroke which brings with it a reduction in size of compression chamber 16. If the pressure in compression chamber 16 exceeds the pressure in outlet duct 28, pressure 38 also formed as a reed valve opens. Here, disk 86 of pressure valve 38 lifts up from outlet opening 32 of intermediate plate 24, as is represented with a dashed line. In the further course of the compressing piston movement, compressed air is pushed out via outlet opening 32 into outlet duct 28 and conducted further, for example, via a line, not shown, connected to outlet duct 28 into a compressed air container, also not represented.

The axial to and fro movement of piston 12 is brought about by a rotating crankshaft 40 which is connected in an articulated manner to piston 12 via a connecting rod 42 and a piston bolt 44. Crankshaft 40 is accommodated in a rotatably mounted manner in a crankcase 46 which is connected to cylinder housing 14. The crankcase 46 is closed off remote from the piston by an oil sump 48 which serves to accommodate an oil supply 50. During operation of air compressor 10, oil spraying up travels from oil supply 50 to inner cylindrical running surface 56 of cylinder housing 14 and hereby lubricates the piston surface as well as at least one piston ring 54 accommodated resiliently in an annular groove 52 of piston 12 and rotatably on the circumferential side.

According to the invention, it is provided in the case of the air compressor 10 that crankcase 46, piston 12, cylinder housing 14 and cylinder head 20 are composed of aluminum or an aluminum alloy, and that one piston ring is produced from a grey cast iron. Since the crankcase, the piston, the cylinder head and the cylinder housing are produced from a material with very good heat conductivity, the compression and friction heat generated during operation of air compressor 10 can be discharged very effectively therefrom so that the efficiency thereof is higher in comparison to conventional air compressors.

Piston ring 54 composed of a great cast iron material is highly suitable as a friction partner for cylindrical running surface 56 of cylinder housing 14, which running surface 56 is composed of aluminum or an aluminum alloy, particularly in the case of oil-lubricated air compressors. In the case of oil-lubricated air compressors, and in the case of air compressors which are not lubricated with oil, piston rings composed of polytetrafluoroethylene (PTFE) can also advantageously be used since this material has very expedient friction properties. In so far as the at least one piston ring is composed of polytetrafluoroethylene, it may, however, be necessary that the cylindrical running surface of the air compressor must be coated separately as the friction partner of the piston ring. Polytetrafluoroethylene can also be used as the coating material.

Crankcase 46, piston 12 and cylinder housing 14 are composed of aluminum or from at least one of aluminum alloys AlSi12 CuNiMg, AlSi17 Cu4MG or AlSi9 Cu3(F2). Accordingly, crankcase 46, piston 12 and cylinder housing 14 can be produced from only one of the stated materials or from in each case various of these materials.

In certain embodiments, the at least one piston ring 54 or the at least one oil scraper ring is composed of a standard grey cast iron material with a hardness of up to 295 HB, from a low-alloyed standard grey cast iron material with a hardness of up to 295 HB, from an alloyed and thermally processed grey cast iron material with a hardness of up to 380 HB, from a tempered spheroidal cast material with a hardness of up to 360 HB, or an alloyed and tempered grey cast iron material with a hardness of up to 410 HB.

In order to achieve particularly good operating characteristics, it is provided that the outer diameter of piston ring 54 is selected in relation to inner diameter 58 of assigned cylindrical running surface 56 of cylinder housing 14 in such a manner that piston ring 54 bears with a contact force of 5 N to 20 N against cylindrical running surface 56. It is judged to be particularly advantageous if piston ring 54 bears with a contact force of 9 N to 13.5 N against cylindrical running surface 56. These contact forces apply to pistons with a diameter of up to 100 mm.

### REFERENCE NUMBERS (PART OF THE DESCRIPTION)

10 Air compressor
12 Piston
14 Cylinder housing
16 Compression chamber
18 Piston upper side
20 Cylinder head
22 Cylinder head upper part
24 Intermediate plate
26 Intake duct
28 Outlet duct
30 Inlet opening in the intermediate plate
32 Outlet opening in the intermediate plate
34 Web of the cylinder head upper part
36 Suction valve
38 Pressure valve
40 Crankshaft
42 Connecting rod
44 Piston bolt
46 Crankcase
48 Oil sump
50 Oil supply
52 Annular groove in the piston
54 Piston ring
56 Cylindrical running surface
58 Inner diameter of the cylindrical running surface
60 Inlet chamber of the cylinder head upper part
62 Outlet chamber of the cylinder head upper part
84 Disk of the suction valve
86 Disk of the pressure valve

What is claimed is:

1. An air compressor to supply a compressed air system of a motor vehicle with compressed air, said air compressor having a crankcase, a cylinder housing connected to the crankcase a cylinder head, a crankshaft arranged in a rotatably mounted manner in the crankcase, a cylindrical piston connected via a connecting rod to the crankshaft, which piston is arranged axially movably along a cylindrical running surface of the cylinder housing, at least one piston ring or oil scraper ring which is arranged in an annular groove on outer lateral surface of the piston, a compression chamber which is formed above the piston and is closed off by the cylinder head, further having an intake duct and an outlet duct which are formed in a cylinder head upper part of the cylinder head, wherein the intake duct is assigned at least one suction valve and the outlet duct is assigned at least one pressure valve, wherein the crankcase, the cylinder housing, the cylinder head and the piston are produced from aluminum or an aluminum alloy, and that the at least one piston ring or the at least one oil scraper ring is produced from grey cast iron or from polytetrafluoroethylene (PTFE).

2. The air compressor as claimed in claim 1, wherein the crankcase, the piston and the cylinder housing are produced from an aluminum alloy which has a silicon ratio of at most 25% and has a hardness of at least 90 HB (Brinell).

3. The air compressor as claimed in claim 1, wherein the cylindrical running surface of the cylinder housing for the piston and/or the at least one piston ring or oil scraper ring is formed from the same material as the cylinder housing.

4. The air compressor as claimed in claim 1, wherein the crankcase, the piston and the cylinder housing are composed of the aluminum alloy AlSi12 CuNiMg, AlSi17 Cu4MG or AlSi9 Cu3(F2).

5. The air compressor as claimed in claim 4, wherein the aluminum alloy comprises AlSi9 Cu3(F2), and the aluminum alloy was heat-treated after the casting process.

6. The air compressor as claimed in claim 1, wherein the at least one piston ring is formed as a groove taper-faced ring or as a taper-faced ring.

7. The air compressor as claimed in claim 1, wherein the at least one piston ring or the at least one oil scraper ring is composed of a standard grey cast iron material with a hardness of up to 295 HB (Brinell), from a low-alloyed standard grey cast iron material with a hardness of up to 295 HB, from an alloyed and thermally processed grey cast iron material with a hardness of up to 380 HB, from a tempered spheroidal cast material with a hardness of up to 360 HB, or an alloyed and tempered grey cast iron material with a hardness of up to 410 HB.

8. The air compressor as claimed in claim 1, wherein the outer diameter of the at least one piston ring is selected in relation to the inner diameter of the assigned cylindrical running surface of the cylinder housing in such a manner that the piston ring bears with a contact force of 5 N to 20 N against the cylindrical running surface.

9. The air compressor as claimed in claim 8, wherein the piston ring bears with a contact force of 9 N to 13.5 N against the cylindrical running surface.

10. The air compressor as claimed in claim 1, wherein the outer diameter of the at least one oil scraper ring is selected in relation to the inner diameter of the assigned cylindrical running surface of the cylinder housing such that the oil scraper ring bears with a contact force of 10 N to 60 N against the cylindrical running surface.

11. The air compressor as claimed in claim 10, wherein the oil scraper ring bears with a contact force of 27.2 N to 40.8 N against the cylindrical running surface.
